(19) United States
(12) Patent Application Publication
(10) Pub. No.: US 2018/0232904 A1
(43) Pub. Date: Aug. 16, 2018

(54) Detection of Risky Objects in Image Frames

(71) Applicant: Seecure Systems, Inc., Belmont, CA (US)

(72) Inventors: Michael Zakharevich, Belmont, CA (US); Boris Kheyn-Kheyfets, New York, NY (US); Alexander Shoshitaishvili, Thousand Oaks, CA (US); Ilya Ravkin, Palo Alto, CA (US)

(73) Assignee: Seecure Systems, Inc.

(21) Appl. No.: 15/894,214

(22) Filed: Feb. 12, 2018

Related U.S. Application Data
(60) Provisional application No. 62/457,702, filed on Feb. 10, 2017.

(51) Int. Cl. G06T 7/70; G06T 7/00; G06K 9/00

(52) U.S. Cl. CPC G06T 7/70; G06T 7/97; G06K 9/00268; G06K 9/00771; G06K 9/00348

(57) ABSTRACT

System, method, and computer product for detection of objects. A plurality of image frames is extracted from an image data received from one or more imaging devices. At least one image frame is selected from the plurality of image frames. A determination is made whether the selected image frame contains at least one imaged object. Using at least one model, an intensity of pixels in the selected image frame is analyzed to determine presence of an anomaly associated with the at least one imaged object. Based on the analysis, a notification is generated upon determination that the anomaly is present in the selected image frame. The notification indicates that the at least one imaged object is suspicious.

### CROSS-REFERENCE TO RELATED APPLICATIONS

The present application claims priority to U.S. Provisional Patent Appl. No. 62/457,702 to Zakharevich et al., filed Feb. 10, 2017, and entitled “Detection Of Risky Objects In Image Frames”, and incorporates its disclosure herein by reference in its entirety.

### TECHNICAL FIELD

In some implementations, the current subject matter generally relates to data processing and in particular, to detection of one or more objects in a graphical image, video, and/or media.

### BACKGROUND

Threats of terrorism have increased tremendously. Many individuals, often acting as lone-wolf actors, not trained terrorists but rather radicalized, commit terrible acts of violence. These problems have arisen not only in the United States of America, but have also been prevalent in many other parts of the world. It is therefore important to accurately detect such individuals before they cause violence.

However, traditional technology to perform such detection is costly and technically ineffective. For example, cameras have been installed at various high traffic locations or security checkpoints, however, conventional detection schemes lack meaningful analysis of data that may be obtained by these devices. In addition to these devices, human manpower has also been extensively used in some places for the purposes of monitoring, detection and/or deterrence of activities. Use of such power is expensive and error prone, as humans have limited concentration abilities, are incapable of digesting large amounts of data that may be captured by the detection devices in order to perform a meaningful analysis of obtained data. Additionally, existing technology is not only costly, but also consumes a significant amount of computing power while producing poor resolution imagery that may be hard or even impossible to analyze. Thus, there exists a need to quickly and accurately perform detection of objects, including harm-intending individuals and/or harmful objects, in the obtained media (e.g., images, video, etc.) prior to such objects causing disturbance, destruction, etc. so that timely prevention of these acts can be achieved, while at the same time conserving computing resources (e.g., power, memory, etc.) and using a variety of quality imagery for quick and accurate analysis.

### SUMMARY

In some implementations, the current subject matter relates to a computer-implemented method for detection of objects. The method can include extracting a plurality of image frames from an image data received from one or more imaging devices, selecting at least one image frame from the plurality of image frames, determining whether the selected image frame contains at least one imaged object, analyzing, using at least one model, an intensity of pixels in the selected image frame to determine presence of an anomaly associated with the imaged object, and generating, based on the analyzing, a notification upon determination that the anomaly is present in the selected image frame, where the notification can indicate that the imaged object is suspicious.

In some implementations, the current subject matter can include one or more of the following optional features. The analysis can include determining a pixel intensity of at least one first pixel included in the selected image frame, the at least one first pixel depicting at least a portion of the at least one imaged object, and comparing the determined pixel intensity of the at least one first pixel to a pixel intensity of at least one second pixel included in another image frame in the plurality of image frames, the at least one second pixel depicting the portion of the at least one imaged object. Further, the generation of notification can include generating the notification upon determination that a difference between pixel intensities of the at least one second pixel and the at least one first pixel is greater than or equal to a predetermined pixel intensity threshold.

In some implementations, the analysis can also include excluding from the analyzing at least one of the selected image frame and the second image frame upon determination that the difference between pixel intensities of the at least one second pixel and the at least one first pixel is less than the predetermined pixel intensity threshold. Also, the analysis can include tracking at least one of excluded selected image frame and the second image frame, and using at least one of excluded selected image frame and the second image frame to train the model.

In some implementations, one or more imaging devices can include at least one of the following: a camera, a camcorder, a body camera, a drone camera, a video camera, a stationary camera.

In some implementations, selection of a portion image frames can include identifying at least one of a feature and a signal within the plurality of image frames captured over a period of time, and detecting the imaged object within each selected image frame based on the identified feature and signal. The features can include parameters associated with still images within the plurality of image frames. The signals can include parameters associated with time and sequence associated with the plurality of image frames.

In some implementations, the method can further include determining, using a location of the imaged object within each selected image frame, at least one of a movement of the imaged object, an interaction between the imaged object and another object, and a correlation between the movement of multiple objects. The method can also include identifying a behavior of the imaged object by comparing the movement of the imaged object, the interaction between the imaged object and another object, and the correlation between the movement of multiple objects with a list of behaviors. Moreover, the method can include tracking at least one of a movement of the at least one imaged object, the interaction between the at least one imaged object and another object, and the correlation between the movement of multiple objects. Further, the method can include assessing a risk associated with the behavior.

In some implementations, extracting can include reducing dimensionality of the image data associated with the plurality of image frames. The dimensionality can be reduced prior to identification at least one of the features and the signals.

In some implementations, the imaged object can be a human being, and the features includes facial features of the human being. The method can further include performing a facial recognition to detect the facial features within each selected image frame. The facial recognition is performed using Eigen faces, Eigen movements (i.e., Eigen vectors of movement correlation matrix), and/or any combination thereof. The Eigen faces can be a plurality of Eigen vectors derived from a covariance matrix of a probability distribution over a multidimensional vector space of face images. Each Eigen vector of a linear transformation can be a non-zero vector that does not change direction when the linear transformation is applied to the Eigen vector.

In some implementations, the imaged object can include at least one human being, at least one animal, at least one vehicle, at least one weapon, at least one non-weapon item, at least one clothing, at least one movable object, at least one immovable object, at least one event, at least one occurrence, at least one motion, at least one light, at least one reflection of light, at least one sound, at least one image, at least one image frame, a plurality of images, and/or any combination thereof.

In some implementations, the method can further include determining the location of the imaged object within each selected image frame by tracking a displacement of object in the plurality of image frames. The displacement of objects in the plurality of image frames can include displacement of objects at a predetermined location.

In some implementations, the list of behaviors can include data characterizing an individual repeatedly looking back and data characterizing an individual staring in a particular direction. The method can also include updating the list of behaviors by at least one of the following: initializing the list of behaviors, adding new behaviors to the list of behaviors, updating the list of behaviors in real-time, updating the list of behaviors at preset intervals of time. In some implementations, identification of the behavior of the imaged object can be performed by applying a principal component analysis. It can also be performed by applying a Laplacian Eigen map analysis.

In some implementations, assessment of the risk can include identifying, using a database, a list of preset hostile situations, and comparing the identified behavior with the list of preset hostile situations to determine a probability of the identified behavior resulting in a hostile situation. The data in the database can include at least one of the following: one or more crime reports for an area where the one or more imaging devices are installed, one or more protocols of monitoring for suspicious activity in the area, expert data available for the area, geographical details of the area, constructional details of the area, one or more terrorist and criminal watch lists for the area, and any combination thereof. The data in the database can be updated at specific intervals of time.

In some implementations, the notification can include at least one of the following: an email, a text message, a video message, an audio message, a social network message, an alarm, a telephone call, a video call, an application programming interface (API) alert, a security warning, an advertisement, a public announcement, and any combination thereof.

In some implementations, the notification can include at least one of the following: data received from a sensor device, global positioning system (GPS) data captured by the sensor device, and any combination thereof. The sensor device can be configured to detect at least one of the following: a motion of the imaged object, global positioning system (GPS) coordinates of the imaged object, audio signals associated with the imaged object, a touch associated with the imaged object, a heat emitted in a vicinity of the sensor device, and any combination thereof.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary system for detection of objects in images, according to some implementations of the current subject matter;

FIG. 1b is a flowchart illustrating an exemplary process that can be performed by the system shown in FIG. 1a, according to some implementations of the current subject matter;

FIG. 1c illustrates a flowchart of an exemplary process that can be performed by the computing server in analyzing the captured/recorded information, according to some implementations of the current subject matter;

FIG. 2 is a flowchart illustrating an exemplary method for detection of objects in images, according to some implementations of the current subject matter;

FIG. 3 illustrates an exemplary environment where the system shown in FIG. 1a can be implemented;

FIG. 4 illustrates an exemplary system, according to some implementations of the current subject matter; and

FIG. 5 illustrates an exemplary method, according to some implementations of the current subject matter.

### DETAILED DESCRIPTION

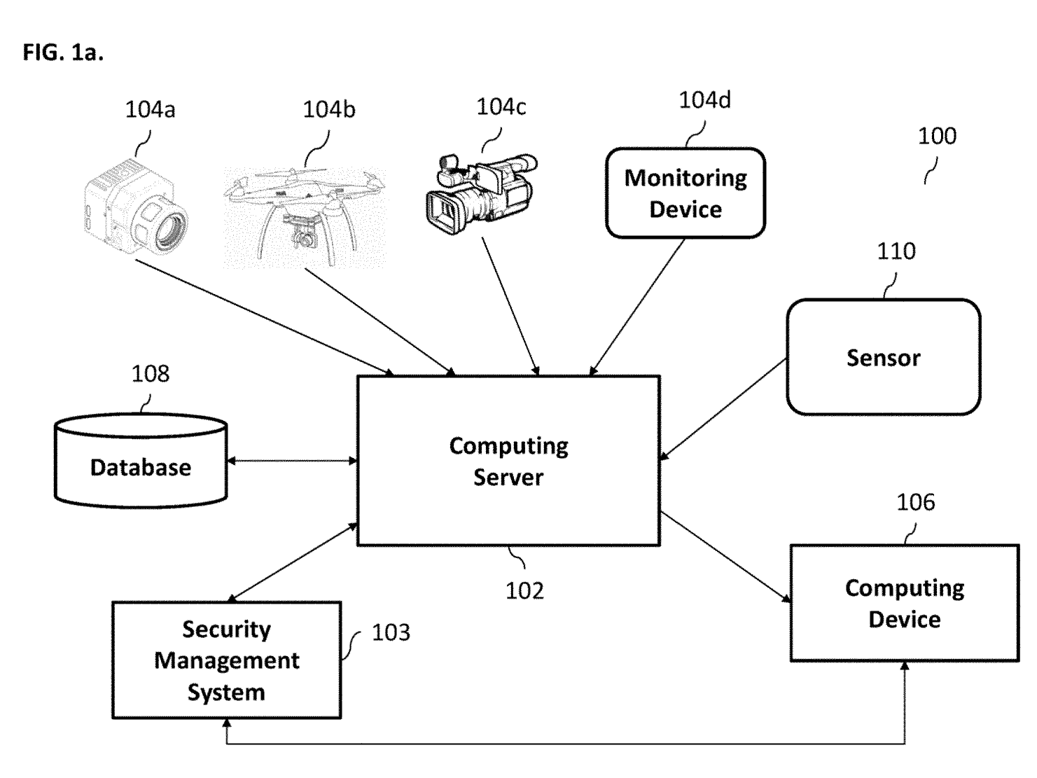

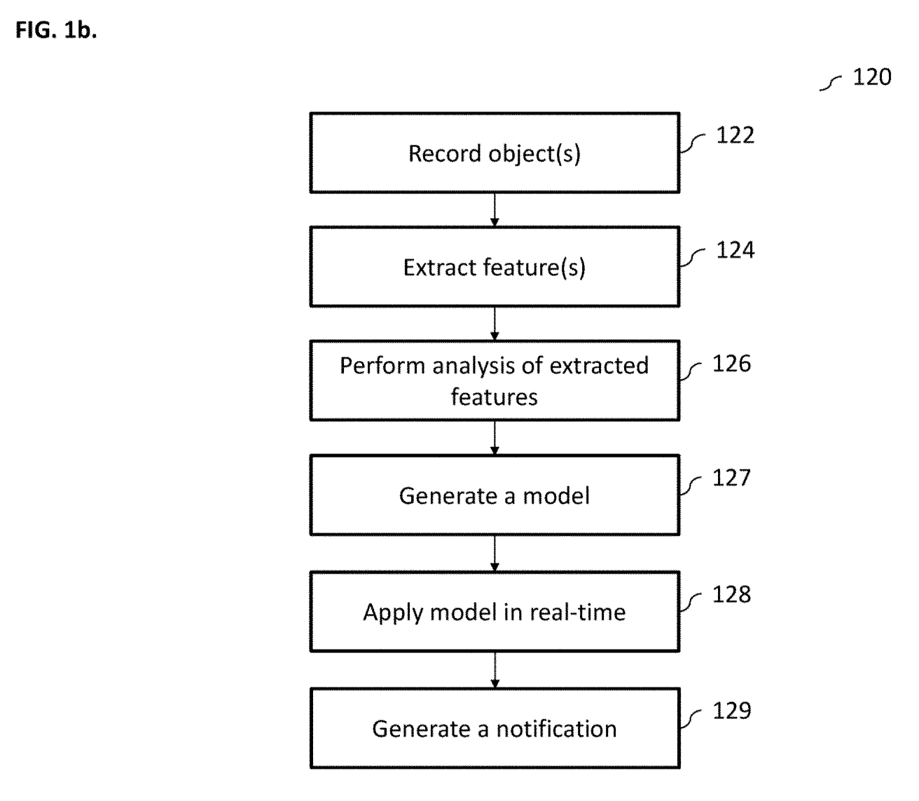

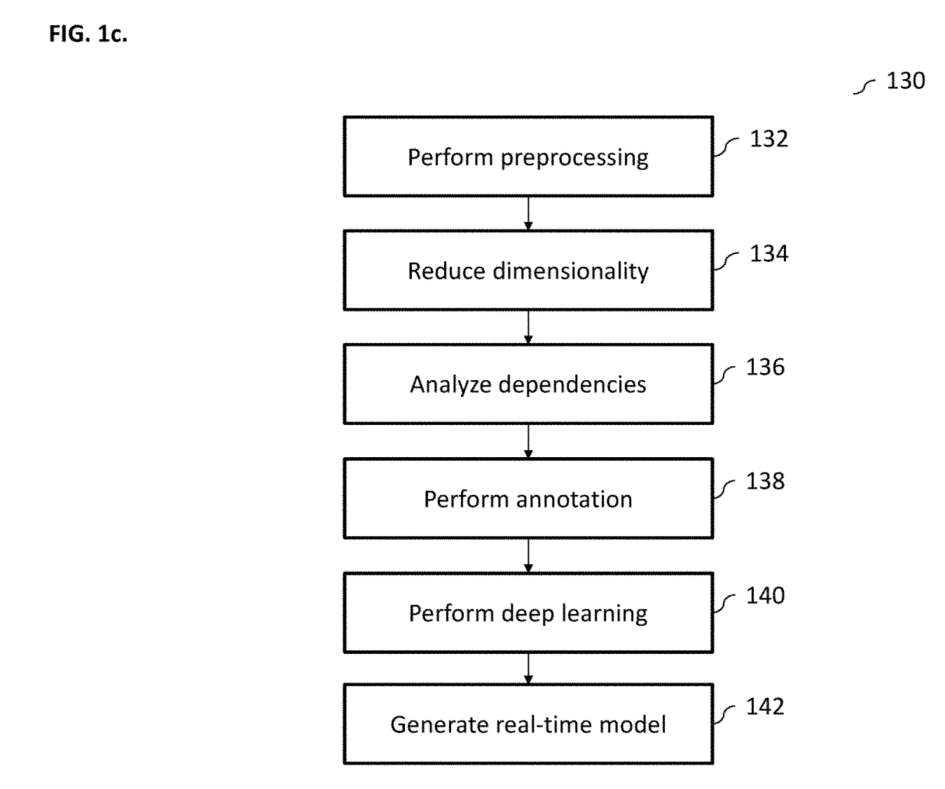

FIG. 1a illustrates an exemplary system 100 for detection of objects in images, according to some implementations of the current subject matter. The system 100 can include a computing server and/or any other processing component and/or group of processing components 102, one or more monitoring and/or recording devices 104 (a, b, c, d), one or more sensor devices 110, one or more databases 108, one or more computing devices 106, and one or more security management system(s) 103. The computing server 102 can be communicatively coupled to the monitoring devices 104, the sensor 110, the computing device 106, the security management system 103, and the database 108 using one or more communications networks. The communications networks can include at least one of the following: a wireless network, a wired network, a metropolitan area network (MAN), a local area network (LAN), a wide area network (WAN), virtual local area network (VLAN), an extranet, an intranet, the Internet, Bluetooth network, infrared network, and/or any other network and/or any combination thereof. Each of the devices 102-110 can include software, hardware, and/or any combination thereof, including but not limited, to one or more computer processors, one or more storage and/or memory locations, one or more graphics, video and/or image processors, etc.

The recording device 104 can include at least one of the following: a body camera, a camcorder, a drone camera, a video camera, and/or any other type of recording device. In some implementations, the recording device 104 can also refer to multiple video and/or audio capturing devices, and/or a network of recording devices. In some implementations, the recording device 104 can be a stationary camera, a moveable camera, a moving camera, and/or any combination thereof. The recording device 104 can be deployed at any desired location, including, for example, but not limited to, a high traffic location, a security sensitive area (e.g., an airport, a railway station, a bus terminal, a tourist attraction, etc.) and/or at any other location, and/or any combination of locations.

In some exemplary implementations, the computing server 102 can include a cloud computing server, a laptop computer, a desktop computer, a tablet computer, a cellular smart phone, a phablet, a datacenter (including but not limited to a datacenter without access to external networks), and/or any other computing device, and/or any combinations thereof. In some exemplary implementations, the computing device 106 can include at least one of the following: a laptop computer, a desktop computer, a tablet computer, a cellular smart phone, a phablet, and/or any other computing device, and/or any combinations thereof.

In some exemplary implementations, the database 108 can include at least one of the following: a hierarchical database, a relational database (for example, a SQL database), a non-relational database, Hadoop database, MapReduce database, and/or any other database and/or any combinations thereof. The database 108 can be either a columnar database and/or a row based database. In some exemplary implementations, the database 108 can be an in-memory database that is embedded within the computing server 102. In an alternate exemplary implementations, the database 108 can be remote to the computing server 102 and/or can be operably coupled to the computing server 102 via a communication network, which can be one or more of: a wired connection, a local area network, a wide area network, internet, intranet, Bluetooth network, infrared network, and/or any other communication networks, and/or any combinations thereof.

In some implementations, the security management system 103 can be an existing security management system that can be configured to interact and/or be integrated with one or more components of the system 100. The system 103 can include its own processing components, memory components, networking components, various hardware devices (including but not limited to cameras, sensors, microphones, etc.). The system 103 can be configured to receive and/or transmit various data from and/or to any of the components of the system 100, including but not limited to, computing server 102 and/or the computing device 106. Alternatively, the system 100 can be configured to be integrated and/or interoperably coupled within the system 103. In some implementations, various middleware components can be part of the system 100 and/or system 103 and can provide various functionalities, including but not limited to, processing, function execution, integration, storage, parallelizing of processes, etc.

In some implementations, the system 100 can be configured to capture and/or record image(s), video(s), any other graphical media, temperature (including that of the object, surrounding environment, etc.), chemical composition, speed, orientation, position, state of being, and/or any other data of an object, a location, an individual, and/or any other item (hereinafter, “object(s)”), detect such object(s), analyze the object(s) to determine one or more feature of and/or associated with the object(s), determine whether the object(s) requires further evaluation (e.g., presents a danger, suspicion, risk, etc.) and generate an alert and/or any other notification. In some exemplary implementations, the object(s) can include at least one of the following: human being(s), animal(s), vehicle(s), weapon(s), non-weapon item(s), clothing, movable object(s), immovable object(s), event(s), occurrence(s), motion(s), light(s), reflection(s) of light(s), sound(s), and/or any combination thereof. Additionally, the object can also include at least one of the following: an image, an image frame, a plurality of images, and/or any combination thereof. The analysis can be of the entire captured image(s), video(s), media, etc. and/or of any portion (e.g., one or more frames (sequential and/or non-sequential), sections, etc.) of the captured image(s), video(s), media, etc. The notification can identify at least one such object(s) and/or the portion of the captured image(s), video(s), media, etc. In some implementations, the notification can include at least one of the following: an email, a text message, a video message, an audio message, a social network message, an alarm, a telephone call, a video call, an application programming interface (API) alert, a security warning, an advertisement, a public announcement, and/or any other type of notification, and/or any combination thereof. The notification can be presented on the computing device 106 so that an appropriate action can be taken, e.g., prevention of any possible harm that may be caused by object(s).

In some implementations, the system 100, based on the information captured by one or more devices 104 and/or sensors 110, can determine features and/or signals, intensity of pixels, and/or any other information within the captured image(s), video(s), media, etc. As will be described below, the system 100 can do so by analyzing one or more frames (e.g., sequential and/or non-sequential) of the captured image(s), video(s), media, etc. The analysis can determine whether object(s) in the captured image(s), video(s), media, etc. presents, for example, a hostile (also referred to as risky or harmful) situation that may require further attention/investigation.

FIG. 1b is a flowchart illustrating an exemplary process 120 that can be performed by the system 100 shown in FIG. 1a, according to some implementations of the current subject matter. At 122, the system 100 can capture one or more image(s), video(s), media of object(s) (e.g., a human, a location, a vehicle, a weapon, etc.). Devices 104 can perform capturing and/or recording of such object(s). The devices 104 can perform constant capturing/recording, and/or can be activated to capture/record based on a specific schedule and/or event (e.g., door opening). For example, a camera 104a (e.g., a traffic camera, a security camera, etc.), a drone 104b (e.g., an aerial drone, etc.), a video camcorder 104c and/or any other devices 104d can be configured to record a video and/or take a still image of the object(s). In addition to video, the devices 104 can be configured to record any other information, including, but not limited to, time of recording, time of day, length of recording, audio, and/or any other information. The sensor(s) 110 can be configured to provide any other information, which can include, humidity, temperature, air quality, presence of harmful chemicals and/or agents, etc. Once that information has been obtained by the devices 104 and/or 110, the information can be supplied to the computing server 102.

At 124, the computing server 102 can perform analysis of captured/recorded information for the purposes of extracting features and/or signals from the captured/recorded information. At 126, the extracted features/signals can be further analyzed to determine pixel intensities and/or variations of pixel intensities in the captured/recorded information. The server 102 can use its analysis of the captured/recorded information, historical data, models, and/or any other data/information to determine whether anomalies exist in the captured/recorded information. In some implementations, the server 102 can also generate data models (at 127), train data models (for example, using historical, gathered, and/or any other data and/or any combination thereof), and apply generated and/or trained data models to analyze obtained information. Further, various neural networks, deep learning systems, etc., can be used for the purposes of generation, training, application, etc. of data models. The server 102 can apply data models in real-time, at 128. In some implementations, the server 102 can be configured to access database(s) 108 to obtain any requisite information that may be required for its analysis. If anomalies are determined to be present, the server 102 can generate a notification and transmit to the computing device 106 (e.g., for display, an audio alert, etc.), at 129. Further, the server 102 can also instruct one or more devices 104 and/or 110 to track a specific object that may be associated with the analyzed captured/recorded information. Additionally, a user using the computing device 106 may also take further action, e.g., dispatch security personnel (e.g., police, etc.), continue monitoring the object(s) through devices 104, etc.

FIG. 1c illustrates a flowchart of an exemplary process 130 that can be performed by the computing server 102 in analyzing the captured/recorded information or, otherwise, referred to as image data, according to some implementations of the current subject matter. The process 130 can be performed by the computing server 130 and/or a plurality of networked computing servers 130. At 132, the image data (e.g., video, image frames, thermal images, infrared images, etc.), which can include one or more image frames, can be pre-processed. In some implementations, various additional data can also be received and processed by the computing server 102, including but not limited, motion data, temperature data, lighting conditions data, humidity data, etc., which can be provided by various sensors 110 (as shown in FIG. 1a). Referring back to FIG. 1c, the processing of image data (and/or any other data) can include gray-scaling the image frames and/or re-sizing them to a predetermined size. By way of a non-limiting example, the predetermined size can be 160×180 pixels. As can be understood, any other size of can be used. It should be noted that for different types of applications (e.g., security, retail, etc.) different predetermined sizes can be used. Further, while conversion of the obtained image date to gray-scale may reduce consumption of processing capacity and/or memory imprint, it is not necessary to convert obtained image data to gray-scale. The computing server 130 can process unconverted image data. However, for the purposes of the following discussion, it is assumed that the obtained image data has been gray-scaled and reduced in size.

Once the obtained images have been gray-scaled and appropriately re-sized, the computing server 102 can perform dimensionality reduction processing, at 134. In some implementations, reduction of dimensions can include extraction of pixel intensity, generation of numerical representation of the pixel information, and use of non-linear techniques to reduce dimensions of the image data. In some implementations, an intensity of a pixel can be defined as an integer from 0 to 255 corresponding to a level of grayscale. Thus, 0 intensity corresponds to a black color and 255 intensity corresponds to a white color. In some implementations, this information can be part of an image data that is obtained and can be stored in various ways depending on the format of the files containing image data. As such, after analysis of the image data, different portions of an image can be assigned a particular numerical value between 0 to 255.

In some implementations, reduction in dimensionality can include one or more of the following operations. First, an image frame (contained in the obtained image data) that has changed less than a predetermined threshold from its previous image frame can be removed. The predetermined threshold can be determined based on the pixel intensity values from one image frame to the next image frame. Alternatively, the predetermined threshold can be preset at a desired value. Second, nonlinear transformations of pixel intensity can be performed and a number of parameters involved in a principal component analysis of the image frames can be reduced to a predetermined minimal number while keeping substantial all (e.g., 99% percent) of statistical variation of the image data. This transformation can be based on a correlation of pixel intensity between different geometrical locations on the image frame. Third, nonlinear transformation of pixel intensity information based on correlation between image frames in different moments in time in the image data (e.g., video episode) can be performed.

Upon reducing dimensionality of the obtained image data, analysis of dependencies can be performed by the computing server 102, at 136. To analyze dependencies in the image data, a principal component analysis (PCA) procedure can be performed. PCA can include an orthogonal transformation that converts a set of observations of possibly correlated variables into a set of values of linearly uncorrelated variables, which are referred to as principal components. The number of distinct principal components can be equal to the smaller of the number of original variables or the number of observations minus one. In the orthogonal transformation, the first principal component has the largest possible variance (i.e., accounting for as much of the variability in the data as possible), and each succeeding component has the highest variance possible under the constraint that it is orthogonal to the preceding components. The orthogonal transformation generates vectors corresponding to an uncorrelated orthogonal basis set. The computing server 102 can perform the PCA procedure for pixel intensities contained in the image frames. For example, the PCA procedure can be performed for 15 frames that can be included in the image data (e.g., video interval or episode). A Laplacian Eigen map can be generated for such 15-frame intervals. In some exemplary, non-limiting, implementations, the video interval can include 150 frames, which can correspond to a “unit of observation”, i.e., a particular video interval recorded over a period of time. As can be understood any number of frames can be included in the video interval for analysis and any number of frames can be selected for performing the PCA procedure. The numbers of frames can also be dependent on a particular use application, e.g., security, retail, etc. Upon completion of the PCA procedure, parameters that explain substantially all variations in pixel intensities can be generated. The variation in pixel intensities can be indicative of an anomaly in an image.

At 138, annotation of the parameters can be performed. The computing server 102 can generate one or more training sets based on the determined parameters. In some implementations, plots of Laplacian parameters for all historic data sets can be generated along with annotations. In some implementations, annotations can be generated automatically and/or manually (e.g., using experts, etc.). The annotations can be generated based on a feedback that can be received, which can include an indication of whether a particular alert is true or false, additional information concerning the generated alert, and/or any other information. Various APIs can be used to receive and/or transmit information, feedback, etc. For example, a heuristic procedure of visual inspection of the Laplacian parameter plots can be used for selection of training sets. In some implementations, historical data sets (i.e., data sets associated with any previously obtained image data) can also contain annotations that may be used for annotation of currently obtained data sets. In some implementations, the data sets (whether historical, current, and/or any other data sets) can be used to train and/or re-train existing models and/or those models that have been generated.

At 140, the annotated parameters can be an input to a deep learning neural network that can be trained for prediction of various actions, e.g., risky behavior, risky objects, etc. in the future. At 142, the output of the deep learning neural network can be presented to the computing server 102 in real time, which can used to generate a notification that can be transmitted to the computing device 106 (e.g., for display as an alert, etc.). The computing server 102 can perform operations 132-140 in real time, which can allow for detection of anomalies (e.g., risky behaviors, risky objects, etc.), tracking of such anomalies, and generation of notification to users.

As stated above, the computing server 102 can receive, from the recording device 104, multiple image frames or video captured over a period of time. The computing server 102 can identify at least one of features and signals within the multiple image frames or video. The computing server 102 can detect, by using the at least one of the features and the signals, one or more objects within each image frame.

The computing server 102 can track, using a location of the one or more objects within each image frame, at least one of a movement of each object, an interaction between two or more objects, and a correlation between the movements of multiple objects. The computing server 102 can identify a behavior of the object by comparing the at least one of the movement of each object, the interaction between two or more objects, and the correlation between the movement of multiple objects with a list of behaviors. As stated above, object(s) can include at least one of the following: human being(s), animal(s), vehicle(s), weapon(s), non-weapon item(s), clothing, movable object(s), immovable object(s), event(s), occurrence(s), motion(s), light(s), reflection(s) of light(s), sound(s), an image, an image frame, a plurality of images, and/or any combination thereof. The computing server 102 can identify behavior characteristics of a sequence of image frames (for example, the entire sequence of image frames) by computing and/or analyzing displacement of the pixels, intensity of the pixels, and other information to recognize existence of a hostile situation. The identification of behavior characteristics of the sequence of image frames can be referred to as an optical flow process. As stated above, the computing server 102 can process and transform this information using different type of dimensionality reduction algorithms as well as normalization and filtering of the data. The computing server 102 can assess, using for example deep learning neural network or machine learning algorithms, a risk associated with the behavior. The computing server 102 can send an alert to a computing device 106 when the risk exceeds a predetermined threshold. The computing server 102 can send the alert in real-time—that is, immediately after the computing server 102 receives the multiple image frames.

As stated above, the computing server 102 can convert each image frame to a gray scale image and rescale the gray scaled image such that the resulting image is a 160×180 pixels image. Although a size of 160×180 pixels is described for the rescaled image, in other implementations any other size can be used.

The computing server 102 can reduce amount of data associated with each image frame. To reduce the dimensionality, the computing server 102 can determine the intensity of each pixel for each image frame (in accordance with the numerical scale of 0 to 255, as discussed above). In some exemplary implementations, when a difference in intensities of a particular pixel in two consecutive image frames is less than a particular threshold, the computing server 102 can remove that pixel in order to save memory space, thereby improving the processing capability of the computing server 102. When a difference in intensities of a particular pixel in two consecutive image frames is equal to or more than a particular threshold, the computing server 102 can retain that pixel in both the image frames, and note the change in the intensity values. The amount of data can be reduced subsequent to the receiving of the multiple image frames and prior to the identifying of the at least one of the features and the signals. The features can include pixels associated with still images within the multiple image frames, and the signals can include pixels associated with time and sequence associated with the multiple image frames.

The dimensionality can be reduced subsequent to the receiving of the multiple image frames and prior to the identifying of the at least one of the features and the signals. The features can include pixels associated with still images within the multiple image frames. The features can include facial features of a human being. The features can include weapon(s), gun(s), knive(s), explosive device(s), and/or other objects and/or any combination of objects. The features can be detected using various approaches such as edge detection, corner detection, blob detection, ridge detection, Hough transform, structure tensor, and/or any other approach and/or any combination thereof. In some implementations, Haar-like features can be used and an adaptive boosting can be performed to improve performance of the above approaches. In some exemplary, non-limiting, implementations, AdaBoost (an adaptive boosting machine learning meta-algorithm) can be used to perform adaptive boosting. A cascade approach can also be used, where predictive performance of feature detection algorithms can be improved based on concatenation of several classifiers, using all information collected from the output from a given classifier as additional information for the next classifier in the cascade. The computing server 102 can eliminate aberrations in detected objects using various techniques, such as multi-scaling techniques.

The computing server 102 can execute a facial recognition algorithm to detect facial features within each image frame separately. In some exemplary, non-limiting implementations, facial algorithms can include at least one of the following: the Viola-Jones algorithm, the Kanade-Lucas-Tomasi (KLT) feature tracker algorithm, and/or any other algorithm and/or any combination of algorithms. The facial recognition algorithm can be executed using Eigen faces and/or Fisher faces. The Eigen faces can be multiple Eigen vectors derived from a covariance matrix of a probability distribution over a multidimensional vector space of face images. Each Eigen vector of a linear transformation can be a non-zero vector that does not change direction when the linear transformation is applied to the Eigen vector. The signals can include pixels associated with time and sequence associated with the multiple image frames. Fisher faces can be basis vectors that define a subspace representation of a set of face images when linear discriminant analysis (LDA) is used. In some exemplary implementations, in addition and/or instead of Eigen faces, Eigen movements and/or other vectors can be used for the purposes of recognition of object's feature(s), motion(s), other object(s), and/or any other information.

In some implementations, the computing server 102 can also track location of one or more objects within each image frame. This can be accomplished by tracking displacement of pixels (whether corresponding to that object and/or any other pixels) in two consecutive image frames. For example, a difference in intensities of the same pixel in two consecutive image frames can be used.

In some exemplary, non-limiting implementations, a list of behaviors can include data characterizing an individual repeatedly looking back, data characterizing an individual staring in a particular direction, data characterizing an individual moving about a particular location (e.g., a secure area, etc.), data characterizing an object crossing a predetermined perimeter, any other data characterizing a physical behavior of an object, and/or any other data and/or any combination thereof. The list of behaviors can be stored within a memory of the computing server 102 and/or in the database 108. In some implementations, the list of behaviors can contain no data, i.e., the computing server 102 can build/generate a list of behaviors based on data that has been obtained and/or any database information that the computing server 102 can obtain (such as from database 108). The computing server 102 can update the list of behaviors (whether existing list or an entirely new list (e.g., that does not contain any data)) by adding new behaviors to the existing list of behaviors. Further, the list of behaviors can be updated in real-time and/or after completion of processes shown and discussed in connection with FIGS. 1b-c above. Moreover, a new list of behaviors can be generated and/or updated at preset intervals of time.

By way of a non-limiting example, a behavior can include at least one of the following: a risky gesture (e.g., an individual attempting to hold and/or holding a risky object), a risky observation (e.g., an individual performing a risky action in a specific area, time, etc., whether or not using a risky object, such as attempting to perform an attack), a sequence of risky gestures leading to a risky action, history/ies of observation (such as at/of a particular area, particular time, individual, group of individuals, situation(s), event(s), occurrence(s), etc.), a specific observation for a particular area, individual, group of individuals, situation(s), event(s), occurrence(s), etc., and/or any other action, and/or any combination thereof. The computing server 102 can use difference in pixel intensity values across multiple image frames to identify risky gestures and/or risky observations. As stated above, the computing server 102 can, for example, select 15 consecutive frames to identify a risky gesture, and select 150 consecutive image frames to identify a risky observation associated with the risky gesture. The 15 frames can be included in the 150 frames and/or overlap with 150 frames and/or be separate from the 150 frames. While 15 and 150 consecutive image frames are described for determining risky gestures and risky observations, any other numbers of image frames can be selected for determination of risky/suspicious gestures and/or risky/suspicious observations.

As discussed above in connection with FIG. 1c, the computing server 102 can identify behavior of an object by applying the principal component analysis procedure on the pixel intensities across multiple image frames. The principal component analysis can be applied in two stages. First, the computing server 102 can generate a correlation matrix across each image frame in a training data set (e.g., a historical data) to determine coordinates corresponding to transformation of pixels that explain variability in pixel intensities. Second, the computing server 102 can generate another correlation matrix between parameters across all risky gestures, as determined by analyzing sets of 15 consecutive image frames, in the training data set (e.g., a historical data) to determine coordinates corresponding to transformation of pixels across of 15 consecutive image frames that explain variability in pixel intensities. Input of the second stage of the principal component analysis can be an output of the first stage of the principal component analysis. The computing server 102 can identify the behavior of an object by applying a Laplacian Eigen map analysis on the coordinates, calculated as an output of the PCA procedure performed before this step, across multiple image frames. In the Laplacian Eigen map analysis, the computing server 102 can generate a graphical plot describing nearest connections between gestures in terms of distance. The input of the Laplacian Eigen map analysis can be an output of the second stage of the principal component analysis procedure.

While Laplacian Eigen map analysis is described above, other types of analyses can be used, including, but not limited to, at least one of the following: Sammon mapping, a self-organizing map, LLC manifold charting, auto-encoders, maximum variance unfolding, curvilinear component analysis, classical scaling, diffeomorphic dimensionality reduction, probabilistic principal component analysis, kernel principal component analysis, isomap, locally linear embedding, manifold alignment, diffusion maps, Hessian LLE, local tangent space analysis—LTSA, and/or any other analyses, and/or any combination thereof.

Further, the computing server 102 can assess the risk as follows. The computing server 102 can retrieve various data from the database 108. The retrieved data can include at least one of the following: one or more crime reports for an area where the recording device 104 is installed, one or more protocols of monitoring for suspicious activity in the area, expert data available for the area, geographical details of the area, constructional details of the area, one or more terrorist and/or criminal watch lists for the area, and/or any other data, and/or any combination thereof. The data in the database 108 can be updated at any time and/or at specific intervals of time. The computing server 102 can identify, based on the retrieved data, a list of preset hostile situations, and expand the list of preset hostile situations upon identification of a new hostile situation based on annotated historical data. The computing server can do so in real-time and/or at any other time. Further, by way of a non-limiting exemplary implementation, the computing server 102 can also update the list using one or more detected anomalies for a particular location/area, time, object, etc. The computing server 102 can compare the identified behavior (determined based on the newly recorded image frames) with the preset hostile situations to compute a probability of the identified behavior resulting in the hostile situation. The determined probability can be compared to a predetermined threshold value. The predetermined threshold can refer to the probability of more than a particular value. By way of a non-limiting example, the particular value of the probability can be 0.5. If the determined probability is greater than the predetermined threshold, then the recorded object/situation can be deemed to be potentially hostile (or hostile).

In some implementations, the computing server 102 can assess the risk using a predictive model that has been trained using a list of preset hostile situations based on annotated historical data. The predictive model can include at least one of the following: a neural network model, a predictive model, a Naïve Bayes model, a k-nearest neighbor algorithm, a majority classifier, support vector machines, random forests, classification and regression trees, multivariate adaptive regression splines, ordinary least square, generalized linear model, logistic regression, generalized additive models, robust regression, semiparametric regression, genetic models, evolution models, and/or any other model, and/or any combination thereof. The predictive model can predict a risky gesture using 15 consecutive image frames, and then predict a risky observation using 150 consecutive image frames when a risky gesture has been found using 15 consecutive image frames. If a risky observation has been determined using the 150 consecutive image frames and this risk exceeds the above predetermined threshold, the computing server 102 can characterize this observation as hostile, suspicious, etc. The computing server 102 can then generate a notification, an alert, etc. and transmit it to the computing device 106.

The alert can be at least one of an email, a text message, a video message, an audio message, a social network message, an alarm, a telephone call, a video call, an application programming interface (API) alert, a security warning, an advertisement, a public announcement, and/or any other type of notification, and/or any combination thereof. The alarm can be helpful in deterring a hostile or risky event. Further, the alert can be one of: a security warning, an advertisement, and a public announcement. The alert can further include data received by the computing server 102 from a sensor device 110. This data can include, for example, global positioning system (GPS) data captured by the sensor device 110. The sensor device 110 can be configured to detect at least one of: motion of the one or more objects, global positioning system (GPS) coordinates of the one or more objects, audio signals associated with the one or more objects, touch associated with the one or more objects, and heat emitted in a vicinity of the sensor device. The computing device 106 can be configured to be operated by a monitoring agent (e.g., system monitor, resource monitor, human monitor, etc.).

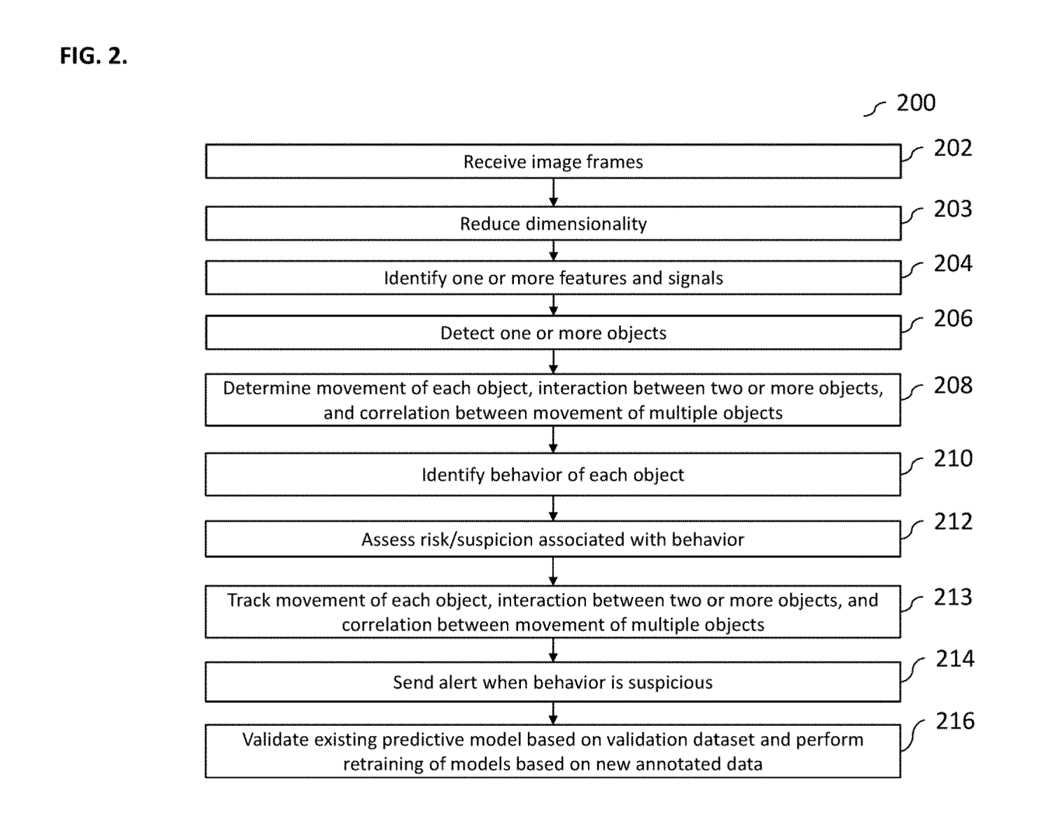

FIG. 2 is a flow diagram illustrating a method for generation of a notification identifying at least one of the risky objects and the suspicious part of the video at a location so that any possible harm caused by those one or more risky objects can be averted. The computing server 102 can receive, at 202 and from the recording device 104, multiple image frames captured over a period of time. Each image frame can be captured by the recording device 104 after a preset time period has lapsed subsequent to a capture of a previous image frame. The computing server 102 can reduce, at 203, the dimensionality of data associated with each image frame. The dimensionality can be reduced subsequent to the receiving of the multiple image frames and prior to the identifying of the at least one of the features and the signals. The features can include pixels associated with still images within the multiple image frames. The signals can include pixels associated with time and sequence associated with the multiple image frames.

The computing server 102 can identify, at 204, at least one of features and signals within the multiple image frames. The features can include facial features of a human being. The features can include gun, knives, or other objects. The features can be detected using various approaches such as edge detection, corner detection, blob detection, ridge detection, Hough transform, structure tensor, structure tensor, and/or any other approach. While using these approaches, in one implementation, Haar-like features can be used, and adaptive boosting can be performed to improve the performance of the approaches being executed. The adaptive boosting can be performed using the AdaBoost. A cascade approach can also be used, wherein predictive performance of feature detection algorithms can be improved based on the concatenation of several classifiers, using all information collected from the output from a given classifier as additional information for the next classifier in the cascade.

The computing server 102 can perform a facial recognition algorithm to detect the facial features within each selected image frame. The facial recognition algorithm can be performed by using Eigen faces. The Eigen faces can be multiple Eigen vectors derived from a covariance matrix of a probability distribution over a multidimensional vector space of face images. Each Eigen vector of a linear transformation can be a non-zero vector that does not change direction when the linear transformation is applied to the Eigen vector. As stated above, other forms of recognition algorithms can be used to detect/determine/analyze various features of the object, where the object can include at least one of the following: human being(s), animal(s), vehicle(s), weapon(s), non-weapon item(s), clothing, movable object(s), immovable object(s), event(s), occurrence(s), motion(s), light(s), reflection(s) of light(s), sound(s), and/or any combination thereof. Additionally, the object can also include at least one of the following: an image, an image frame, a plurality of images, and/or any combination thereof.

The computing server 102 can detect, at 206 and by using the at least one of the features and the signals, one or more objects within each image frame. The one or more objects can include one or more of: at least one human being, at least one vehicle, at least one weapon, clothing, and/or any other object and/or any combinations thereof.

The computing server 102 can determine, at 208 and using a location of the one or more objects within each image frame, at least one of a movement of each object, an interaction between two or more objects, and a correlation between the movement of multiple objects. The computing server 102 can track the location of the object one or more objects within each image frame by tracking a displacement of pixels in two (and/or any other number of) consecutive and/or non-consecutive image frames. The list of behaviors can include data characterizing a person repeatedly looking back and data characterizing a person staring in a particular direction. The list of behaviors can be stored within a memory device of the computing server. The computing server can update the list of behaviors by adding new behaviors to the list of behaviors. The list of behaviors can be updated in real-time. Alternately, the new list of behaviors can be updated at preset intervals of time.

The computing server 102 can identify, at 210, a behavior of the object by comparing the at least one of the movement of each object, the interaction between two or more objects, and the correlation between the movement of multiple objects with a list of behaviors. The computing server 102 can identify the behavior of the object by applying a principal component analysis. The computing server 102 can alternately or additionally identify the behavior of the object by applying a Laplacian Eigen map analysis.

The computing server 102 can assess, at 212, a risk associated with the behavior. The computing server 102 can assess the risk as follows. The computing server 102 can retrieve, from a database 108 operably coupled to the computing server 102, data in the database 108. The computing server 102 can identify, based on the data retrieved from the database 108, a list of preset hostile situations based on annotated historical data. The computing server 102 can compare the identified behavior with the preset hostile situations to compute a probability of the identified behavior resulting in the hostile situation. The predetermined threshold can refer to the probability of more than a particular value. The particular value of the probability can be 0.5.

The data in the database 108 can include at least one of: one or more crime reports for an area where the at least one of the camera and the sensor device are installed, one or more protocols of monitoring for suspicious activity in the area, expert data available for the area, geographical details of the area, constructional details of the area, and one or more terrorist and criminal watch lists for the area. The data in the database may be updated at specific intervals of time.

At 213, the server 102 can track at least one of the movement of each object, the interaction between two or more objects, and the correlation between movement of multiple objects. The computing server 102 can send, at 214, an alert to the computing device 106 when the risk exceeds a predetermined threshold. The computing server 102 can send the alert in real-time—that is, immediately after the computing server 102 receives the multiple image frames at 202. The alert can be at least one of an email, a text message, a video message, an audio message, a social network message, an alarm, a telephone call, a video call, an application programming interface (API) alert, a security warning, an advertisement, a public announcement, and/or any other type of notification, and/or any combination thereof. Further, the alert can be one of: a security warning, an advertisement, and a public announcement.

The alert can further include data received by the computing server 102 from one or more sensor device(s) 110. This data can include, for example, global positioning system (GPS) data captured by the sensor device 110. The sensor device 110 can be configured to detect at least one of the following: a motion of the one or more objects, global positioning system (GPS) coordinates of the one or more objects, audio signals associated with the one or more objects, touch associated with the one or more objects, heat emitted in a vicinity of the sensor device, and/or any other data, and/or any combinations thereof. The computing device 106 can be configured to be operated by a monitoring agent.

Although the alert is described above as occurring after 206-210, in some implementations 206-210 may not be necessary for generating the alert. For example, the computing server 102 can send, at 214, the alert after just identifying variations in pixel intensity. In those implementations, the computing server 102 may not require identification of all objects on the video to recognize security event and initiate alarm.

The computing server 102 can validate, at 216, existing predictive model based on validation dataset and perform retraining of models based on new annotated data.

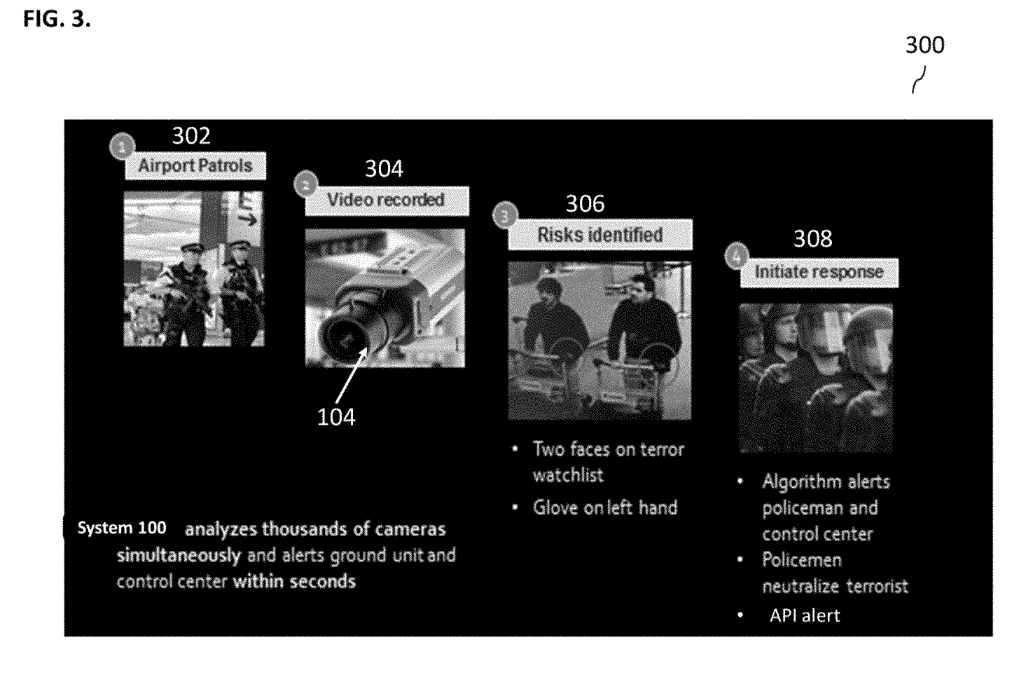

FIG. 3 illustrates one implementation of the system 100 to capture a video of a location, identify one or more objects—for example, human beings, vehicles, weapons, clothing, and/or the like—that are deemed to be suspicious or risky, and generate a notification identifying at least one of the risky objects and the suspicious part of the video so that any possible harm caused by those one or more risky objects can be averted. At a high traffic location, such as an airport, law enforcement personnel may patrol the area at 302. The camera 104 can capture, at 304, multiple image frames of a video of that area. The computing server 102 (not shown in FIG. 3) can assess, at 306, a risk associated with one or more objects identified in each image frame. The computing server 102 can generate and send an alert to the law enforcement personnel when the risk associated with a particular object exceeds a threshold value. Upon being notified, the law enforcement personnel can initiate, at 308, an action to prevent any possible harm that can be caused by that particular risky object.

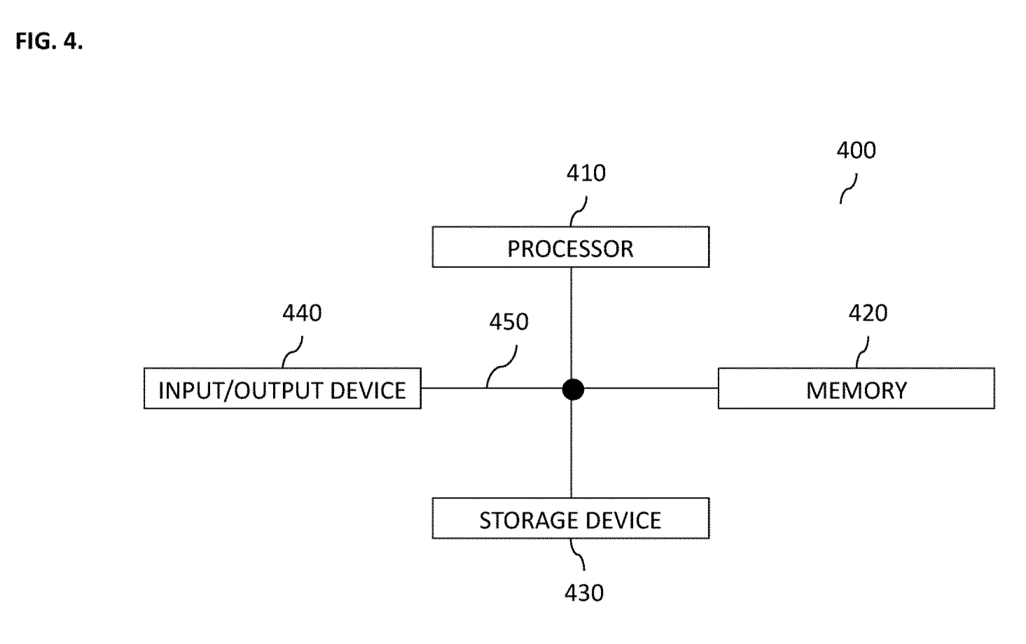

In some implementations, the current subject matter can be configured to be implemented in a system 400, as shown in FIG. 4. The system 400 can include one or more of a processor 410, a memory 420, a storage device 430, and an input/output device 440. Each of the components 410, 420, 430 and 440 can be interconnected using a system bus 450. The processor 410 can be configured to process instructions for execution within the system 600. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

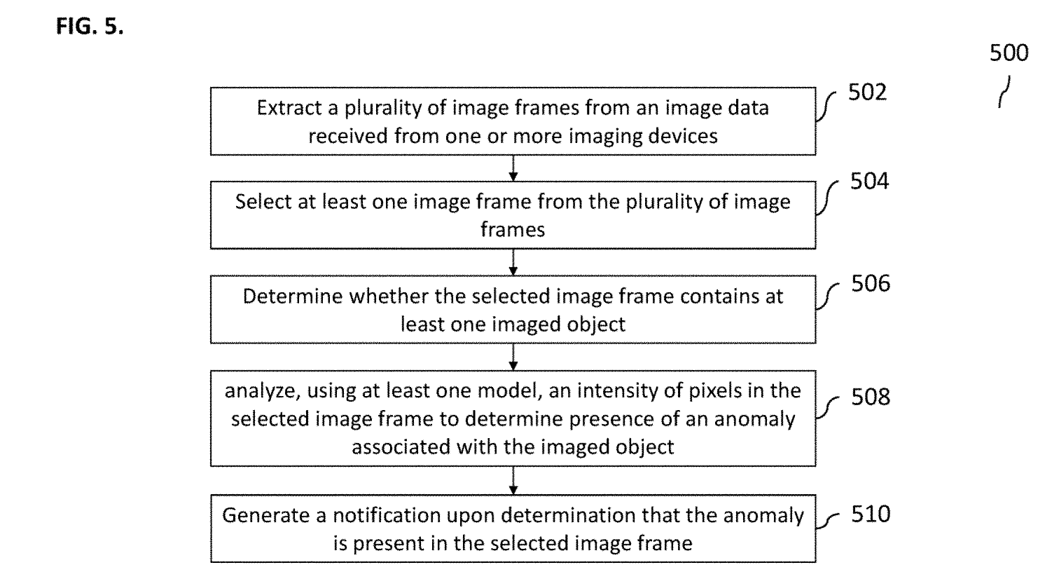

FIG. 5 illustrates an exemplary method 500 for detection of objects in a graphical data (e.g., videos, images, and/or any other media), according to some implementations of the current subject matter. At 502, a plurality of image frames can be extracted from an image data received from one or more imaging devices. At 504, at least one image frame can be selected from the plurality of image frames. At 506, the server 102 can determine whether the selected image frame contains at least one imaged object. At 508, using at least one model, an intensity of pixels in the selected image frame can be analyzed to determine presence of an anomaly associated with the imaged object. At 510, based on the analysis, the server 102 can generate a notification upon determination that the anomaly is present in the selected image frame. The notification can indicate that the imaged object is suspicious.

In some implementations, the current subject matter can include one or more of the following optional features. The analysis can include determining a pixel intensity of at least one first pixel included in the selected image frame, the at least one first pixel depicting at least a portion of the at least one imaged object, and comparing the determined pixel intensity of the at least one first pixel to a pixel intensity of at least one second pixel included in another image frame in the plurality of image frames, the at least one second pixel depicting the portion of the at least one imaged object. Further, the generation of notification can include generating the notification upon determination that a difference between pixel intensities of the at least one second pixel and the at least one first pixel is greater than or equal to a predetermined pixel intensity threshold.

In some implementations, the analysis can also include excluding from the analyzing at least one of the selected image frame and the second image frame upon determination that the difference between pixel intensities of the at least one second pixel and the at least one first pixel is less than the predetermined pixel intensity threshold. Also, the analysis can include tracking at least one of excluded selected image frame and the second image frame, and using at least one of excluded selected image frame and the second image frame to train the model.

In some implementations, one or more imaging devices can include at least one of the following: a camera, a camcorder, a body camera, a drone camera, a video camera, a stationary camera.

In some implementations, selection of a portion image frames can include identifying at least one of a feature and a signal within the plurality of image frames captured over a period of time, and detecting the imaged object within each selected image frame based on the identified feature and signal. The features can include parameters associated with still images within the plurality of image frames. The signals can include parameters associated with time and sequence associated with the plurality of image frames.

In some implementations, the method can further include determining, using a location of the imaged object within each selected image frame, at least one of a movement of the imaged object, an interaction between the imaged object and another object, and a correlation between the movement of multiple objects. The method can also include identifying a behavior of the imaged object by comparing the movement of the imaged object, the interaction between the imaged object and another object, and the correlation between the movement of multiple objects with a list of behaviors. Moreover, the method can include tracking at least one of a movement of the at least one imaged object, the interaction between the at least one imaged object and another object, and the correlation between the movement of multiple objects. Further, the method can include assessing a risk associated with the behavior.

In some implementations, extracting can include reducing dimensionality of the image data associated with the plurality of image frames. The dimensionality can be reduced prior to identification at least one of the features and the signals.

In some implementations, the imaged object can be a human being, and the features includes facial features of the human being. The method can further include performing a facial recognition to detect the facial features within each selected image frame. The facial recognition is performed using Eigen faces, Eigen movements (i.e., Eigen vectors of movement correlation matrix), and/or any combination thereof. The Eigen faces can be a plurality of Eigen vectors derived from a covariance matrix of a probability distribution over a multidimensional vector space of face images. Each Eigen vector of a linear transformation can be a non-zero vector that does not change direction when the linear transformation is applied to the Eigen vector.

In some implementations, the imaged object can include at least one human being, at least one animal, at least one vehicle, at least one weapon, at least one non-weapon item, at least one clothing, at least one movable object, at least one immovable object, at least one event, at least one occurrence, at least one motion, at least one light, at least one reflection of light, at least one sound, at least one image, at least one image frame, a plurality of images, and/or any combination thereof.

In some implementations, the method can further include determining the location of the imaged object within each selected image frame by tracking a displacement of object in the plurality of image frames. The displacement of objects in the plurality of image frames can include displacement of objects at a predetermined location.

In some implementations, the list of behaviors can include data characterizing an individual repeatedly looking back and data characterizing an individual staring in a particular direction. The method can also include updating the list of behaviors by at least one of the following: initializing the list of behaviors, adding new behaviors to the list of behaviors, updating the list of behaviors in real-time, updating the list of behaviors at preset intervals of time. In some implementations, identification of the behavior of the imaged object can be performed by applying a principal component analysis. It can also be performed by applying a Laplacian Eigen map analysis.

In some implementations, assessment of the risk can include identifying, using a database, a list of preset hostile situations, and comparing the identified behavior with the list of preset hostile situations to determine a probability of the identified behavior resulting in a hostile situation. The data in the database can include at least one of the following: one or more crime reports for an area where the one or more imaging devices are installed, one or more protocols of monitoring for suspicious activity in the area, expert data available for the area, geographical details of the area, constructional details of the area, one or more terrorist and criminal watch lists for the area, and any combination thereof. The data in the database can be updated at specific intervals of time.

In some implementations, the notification can include at least one of the following: an email, a text message, a video message, an audio message, a social network message, an alarm, a telephone call, a video call, an application programming interface (API) alert, a security warning, an advertisement, a public announcement, and any combination thereof.

In some implementations, the notification can include at least one of the following: data received from a sensor device, global positioning system (GPS) data captured by the sensor device, and any combination thereof. The sensor device can be configured to detect at least one of the following: a motion of the imaged object, global positioning system (GPS) coordinates of the imaged object, audio signals associated with the imaged object, a touch associated with the imaged object, a heat emitted in a vicinity of the sensor device, and any combination thereof.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
extracting a plurality of image frames from an image data received from one or more imaging devices;
selecting at least one image frame from the plurality of image frames;
determining whether the selected image frame contains at least one imaged object;
analyzing, using at least one model, an intensity of pixels in the selected image frame to determine presence of an anomaly associated with the at least one imaged object; and
generating, based on the analyzing, a notification upon determination that the anomaly is present in the selected image frame, the notification indicating that the at least one imaged object is suspicious.

2. The method according to claim 1, wherein the analyzing further comprises
determining a pixel intensity of at least one first pixel included in the selected image frame, the at least one first pixel depicting at least a portion of the at least one imaged object; and
comparing the determined pixel intensity of the at least one first pixel to a pixel intensity of at least one second pixel included in another image frame in the plurality of image frames, the at least one second pixel depicting the portion of the at least one imaged object.

3. The method according to claim 2, wherein the generating further comprises
generating the notification upon determination that a difference between pixel intensities of the at least one second pixel and the at least one first pixel is greater than or equal to a predetermined pixel intensity threshold.

4. The method according to claim 3, wherein the analyzing further comprises
excluding from the analyzing at least one of the selected image frame and the second image frame upon determination that the difference between pixel intensities of the at least one second pixel and the at least one first pixel is less than the predetermined pixel intensity threshold.

5. The method according to claim 4, wherein the analyzing further comprises
tracking the at least one excluded selected image frame and the second image frame; and
using the at least one excluded selected image frame and the second image frame to train the at least one model.

6. The method according to claim 1, wherein the one or more imaging devices includes at least one of the following: a camera, a camcorder, a body camera, a drone camera, a video camera, a stationary camera, and any combination thereof.

7. The method according to claim 1, wherein the selecting further comprises
identifying at least one of a feature and a signal within the plurality of image frames captured over a period of time; and
detecting the at least one imaged object within each selected image frame based on the at least one identified feature and signal;
wherein the features include parameters associated with still images within the plurality of image frames, and the signals include parameters associated with time and sequence associated with the plurality of image frames.

8. The method according to claim 7, further comprising
determining, using a location of the at least one imaged object within each selected image frame, at least one of a movement of the at least one imaged object, an interaction between the at least one imaged object and another object, and a correlation between movement of multiple objects;
identifying a behavior of the at least one imaged object by comparing the at least one of the movement of the at least one imaged object, the interaction between the at least one imaged object and another object, and the correlation between the movement of multiple objects with a list of behaviors;
tracking the at least one of a movement of the at least one imaged object, the interaction between the at least one imaged object and another object, and the correlation between the movement of multiple objects; and
assessing a risk associated with the behavior.

9. The method according to claim 7, wherein the extracting further comprises
reducing dimensionality of the image data associated with the plurality of image frames, wherein the dimensionality is reduced prior to identification of at least one of the features and the signals.

10. The method according claim 1, wherein the at least one imaged object is a human being, and the features includes facial features of the human being.

11. The method according to claim 10, further comprising performing a facial recognition to detect the facial features within each selected image frame.

12. The method according to claim 11, wherein the facial recognition is performed using at least one of the following Eigen faces, Eigen movements, and any combination thereof.

13. The method according to claim 1, wherein the at least one imaged object includes at least one of the following: at least one human being, at least one animal, at least one vehicle, at least one weapon, at least one non-weapon item, at least one clothing, at least one movable object, at least one immovable object, at least one event, at least one occurrence, at least one motion, at least one light, at least one reflection of light, at least one sound, at least one image, at least one image frame, a plurality of images, and/or any combination thereof.

14. The method according to claim 8, further comprising determining the location of the at least one imaged object within each selected image frame by tracking a displacement of objects in the plurality of image frames.

15. The method according to claim 14, wherein the displacement of objects in the plurality of image frames includes displacement of objects at a predetermined location.

16. The method according to claim 8, wherein the list of behaviors includes data characterizing an individual repeatedly looking back and data characterizing an individual staring in a particular direction.

17. The method according to claim 8, further comprising updating the list of behaviors by at least one of the following: initializing the list of behaviors, adding new behaviors to the list of behaviors, updating the list of behaviors in real-time, updating the list of behaviors at preset intervals of time, and any combinations thereof.

18. The method according to claim 8, wherein the identifying the behavior of the at least one imaged object is performed by applying a principal component analysis.

19. The method according to claim 8, wherein the identifying of the behavior of the object is performed by applying a Laplacian Eigen map analysis.

20. The method according to claim 8, wherein the assessing the risk further comprises
identifying, using a database, a list of preset hostile situations;
comparing the identified behavior with the list of preset hostile situations to determine a probability of the identified behavior resulting in a hostile situation.

21. The method according to claim 20, wherein the data in the database includes at least one of the following: one or more crime reports for an area where the one or more imaging devices are installed, one or more protocols of monitoring for suspicious activity in the area, expert data available for the area, geographical details of the area, constructional details of the area, one or more terrorist and criminal watch lists for the area, and any combination thereof.

22. The method according to claim 21, wherein the data in the database is updated at specific intervals of time.

23. The method according to claim 1, wherein the notification includes at least one of the following: an email, a text message, a video message, an audio message, a social network message, an alarm, a telephone call, a video call, an application programming interface (API) alert, a security warning, an advertisement, a public announcement, and any combination thereof.

24. The method according to claim 1, wherein the notification includes at least one of the following: data received from a sensor device, global positioning system (GPS) data captured by the sensor device, and any combination thereof.

25. The method according to claim 24, wherein the sensor device is configured to detect at least one of the following: a motion of the at least one imaged object, global positioning system (GPS) coordinates of the at least one imaged object, audio signals associated with the at least one imaged object, a touch associated with the at least one imaged object, a heat emitted in a vicinity of the sensor device, and any combination thereof.

26. A system comprising:
at least one programmable processor; and
a non-transitory machine-readable medium storing instructions that, when executed by the at least one programmable processor, cause the at least one programmable processor to perform operations comprising:
extracting a plurality of image frames from an image data received from one or more imaging devices;
selecting at least one image frame from the plurality of image frames;
determining whether the selected image frame contains at least one imaged object;
analyzing, using at least one model, an intensity of pixels in the selected image frame to determine presence of an anomaly associated with the at least one imaged object; and
generating, based on the analyzing, a notification upon determination that the anomaly is present in the selected image frame, the notification indicating that the at least one imaged object is suspicious.

27. A computer program product comprising a non-transitory machine-readable medium storing instructions that, when executed by at least one programmable processor, cause the at least one programmable processor to perform operations comprising:
extracting a plurality of image frames from an image data received from one or more imaging devices;
selecting at least one image frame from the plurality of image frames;
determining whether the selected image frame contains at least one imaged object;
analyzing, using at least one model, an intensity of pixels in the selected image frame to determine presence of an anomaly associated with the at least one imaged object; and
generating, based on the analyzing, a notification upon determination that the anomaly is present in the selected image frame, the notification indicating that the at least one imaged object is suspicious.
